(19) United States
(12) Patent Application Publication
(10) Pub. No.: US 2010/0193221 A1
(43) Pub. Date: Aug. 5, 2010

(54) CABLE MANAGEMENT DEVICE, AUDIO PLAYBACK APPARATUS, AND METHOD OF MANAGING CABLES

(75) Inventors: Michael Schoeffmann, Baden (AT); Mark Hannah, Bad Fischau-Brunn (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/671,214

(22) PCT Filed: Jul. 28, 2008
(86) PCT No.: PCT/IB08/53021

§ 371 Date: Jan. 29, 2010

(30) Foreign Application Priority Data
Aug. 3, 2007 (EP) 07113729.3

(51) Int. Cl. H02G 11/02

(52) U.S. Cl. 174/135

(57) ABSTRACT

A cable management device (110), the cable management device (110) comprising a casing (111) having a first guiding opening (112) through which a first cable (114) connected to a first electric member (116) is guidable, having a second guiding opening (113) through which a second cable (115) connected to a second electric member (117) is guidable, and having an accommodation chamber (400) for accommodating at least the first electric member (116), and a cover element (118) being movably mounted on the casing (111) to selectively expose or cover the accommodation chamber (400).

### FIELD OF THE INVENTION

The invention relates to a cable management device.

Beyond this, the invention relates to an audio playback apparatus.

Moreover, the invention relates to a method of managing cables of an audio playback apparatus.

### BACKGROUND OF THE INVENTION

Audio playback devices become more and more important. Particularly, an increasing number of users buy headphone-based audio apparatuses.

Portable electronic devices are intended for recording or playback of acoustic signals. For many applications it is necessary to have a headset, typically comprising one or more loudspeakers in the form of one or two earplug, or one or more microphones. For example, by using a headset, a user of mobile phones can enjoy more privacy when the others around cannot hear the telephone conversation. The loudspeaker and a microphone are usually connected to the portable electronic device by using a headset wire which usually includes two pair of wires. One annoying feature of two wire pairs is that they get easily entangled.

U.S. Pat. No. 5,832,098 discloses an earphone/microphone assembly which has a main body, an earphone/microphone union device, and a connection wire connected to the main body and the earphone/microphone union device. The main body has a base seat, a wire receiving disk disposed in the base seat, a plurality of annular bosses formed on the wire receiving disk, a reel disk disposed in the base seat to cover the wire receiving disk, a plurality of reeds disposed on a bottom of the reel disk, a center recess hole formed on the reel disk, a magnet disposed in the reel disk, an annular groove formed on the reel disk, and a hollow casing covering the base seat. The hollow casing has a through hole. A plug is disposed on the hollow casing. A lead wire surrounds the annular bosses. An end of the connection wire is connected to one of the reeds. The connection wire winds the annular groove.

However, such audio playback systems may be inconvenient in use since cable jam may occur.

### OBJECT AND SUMMARY OF THE INVENTION

It is an object of the invention to provide a cable management system which is convenient in use.

In order to achieve the object defined above, a cable management device, an audio playback apparatus, and a method of managing cables according to the independent claims are provided.

According to an exemplary embodiment of the invention, a cable management device is provided, the cable management device comprising a casing (such as a hollow housing or bag) having a first guiding opening (such as one or more first holes in a wall of the casing) through which a first cable (which may comprise one or more wires, each adapted for carrying electric signals, and optionally being electrically insulated) connected to a first electric member (such as earpieces) is guidable, having a second guiding opening (such as one or more second holes in a wall of the casing) through which a second cable (which may comprise one or more wires, each adapted for carrying electric signals, and optionally being electrically insulated) connected to a second electric member (such as a plug or an audio source) is guidable, and having an accommodation chamber (for instance a cavity) for accommodating at least the first electric member, and a cover element (such as a cap) being movably mountable or mounted on the casing (particularly movably relative to the casing) to selectively expose (particularly to enable a user to have access to the interior of the accommodation chamber) or cover (particularly to disable a user to have access to the interior of the accommodation chamber) the accommodation chamber.

According to another exemplary embodiment of the invention, an audio playback apparatus is provided, the audio playback apparatus comprising a first cable connected to a first electric member and being adapted for carrying audio signals, a second cable connected to a second electric member and being adapted for carrying audio signals, and a cable management device having the above mentioned features.

According to still another exemplary embodiment of the invention, a method of managing cables using a cable management device having the above mentioned features is provided, the method comprising winding at least a portion of at least one of the group consisting of the first cable and the second cable around the casing.

According to an exemplary embodiment of the invention, a system for handling cables or wires of an electronic device may be provided in which two openings may be foreseen in opposing sidewalls of a casing or housing which has a sufficiently large inner volume capable of temporarily receiving or storing electric members such as earpieces connected to (for instance an end portion of) one of the cables. By winding the cables guided through the respective guiding openings around the casing, a user may conveniently and accurately adjust a desired length of the cable which remains unwound and can therefore be used for any user-specific purpose, for instance to give a user a freedom of using an audio playback device with cables of a user-defined length. However, if the user desires to store the cables, she or he may wind the cables connected to the first electric member such as earpieces and/or connected to the second electric member such as a plug for connection to a socket or to a connected periphery device such as a CD player. The user may further store the first electric member (and optionally also the second electric member) within the inner volume of the casing. The cover element may be moved (particularly folded) with regard to the casing so as to selectively shield the accommodation chamber with regard to external influences. It may therefore be possible to prevent the first electric member when being received in the accommodation chamber from being influenced by external influences such as mechanical forces, humidity, dirt, etc. This may allow to use the audio playback apparatus or more generally the cable management device even under harsh conditions. With only very low effort, generally with a few hand movements, the user may convert the system between a passive mode in which the cable is wound around the casing and the first electric member is located in the accommodation chamber and an active mode in which at a maximum a part of the cable is wound around the casing and the first electric member is outside of the accommodation chamber, for instance is positioned close to an ear of a listener for audio playback purposes.

Therefore, a bag may be provided to prevent cable jam with wired headsets. Such a bag or other storage device may be designed to hold cables or wires, specifically wires for headphones. Particularly, exemplary embodiments of the invention provide a textile bag at a connector side of a headphone wire which covers the cable after use or protect the cable length which is currently not needed. Therefore, a simple and robust cable management for headphones, particularly for cord based headphones, may be provided.

Particularly, a one-part system is provided which may be securely prevented from being lost. Furthermore, the disclosed one-part system has a rather high durableness. Therefore, a cable management system for a headphone is provided, namely a cord that winds up manually around a carry case for storage.

Within the casing, a cavity may be formed which may also be denoted as an accommodation well and which may be delimited by a bottom plate and lateral walls. Therefore, it may be easy for a user to store earpieces or other electric components connected to or attached to the cables within such an accommodation bag. By closing the cover and fixing the cover element at the casing, for instance with a snap-in fastening mechanism, the cavity may be decoupled from an environment. Furthermore, since both cables (each comprising one or more interior wires) extending through the respective guiding holes can be wound a selectable number of times around the casing, the length of the cables on either side can be adjusted accurately and easily.

Next, further exemplary embodiments of the cable management device will be explained. However, these embodiments also apply to the audio playback apparatus and to the method.

The casing may be adapted to allow for a winding of at least a portion of at least one of the group consisting of the first cable and the second cable around the casing. For this purpose, the dimension of the casing may be selected so that “one” winding results in a corresponding shortening of the cable. The positions of the various guiding openings may be adjusted in such a manner that a simultaneous parallel winding of the first cable and of the second cable around the outer contour of the casing does not result in undesired interactions. For instance, guiding elements (such as grooves) may be foreseen around a circumference of the casing to simplify appropriate winding for a user in an intuitive manner. The guiding openings may be provided on different (for instance opposing) sidewalls of the casing and may be spaced to one another in a direction perpendicular to a winding direction to prevent undesired interaction between the first and the second cable. As an alternative to the provision of the guiding openings on/in opposing sidewalls of the casing, it is also possible to provide the guiding openings on/in one common sidewall or on/in two adjacent sidewalls of the casing.

Particularly, the casing may have a recess in a surface portion adjacent to the cover element when covering the accommodation chamber to thereby allow for a winding of at least a portion of at least one of the group consisting of the first cable and the second cable around the casing even when the cover element covers the accommodation chamber. Such a recess or groove may be shaped and dimensioned in such a manner that, even when both cables are wound essentially along their entire length around the casing and are embedded in the recess in each of the windings, it is still possible to close the cover element (without the wound cables blocking such a closure) to securely protect electric members stored in the accommodation chamber even when the cables are entirely wound up. Particularly, the recess may be essentially C-shaped promoting an accommodation of the cables in a central portion of the recess.

In an embodiment, it is possible to first wind the cables around the casing passing the recess at each turning, then to store the first electric member(s) in the accommodation chamber, and to subsequently close the accommodation chamber by moving, particularly folding the cover element onto an opening of the casing.

The cover element may be pivotally mounted on the casing to selectively expose or cover the accommodation chamber. By pivoting or rotating the cover element to open or close the accommodation chamber, a single hand movement may be sufficient to bring the cable management device from a stored operation state into a usable operation state, or vice versa. A rotation axis may lie in a contact plane in which cover element and casing contact each other in a closed operation mode. However, it is also possible that a rotation axis is perpendicular to the contact plane between cover element and casing. In such an embodiment, the cover element may be rotatable by 360° to open or close the accommodation chamber.

The casing may be made of a rigid or of a flexible material. For example, the casing may be made of a plastics material such as polyethylene or may be made of a flexible textile material. The fastening mechanism for closing the accommodation chamber may be realized by a snap-in connection, by a magnetic fastening, by a Velcro fastener or by a zip fastener for connecting the cover element at the casing. The casing may be permanently fixed, assembled or mounted on the casing. Alternatively, the cover element may be provided detachably or removably from the casing.

The accommodation chamber may be adapted for accommodating two earpieces. Thus, the dimension of the accommodation chamber may be such that there is enough space to receive two earpieces. More particularly, the accommodation chamber may have various sub-chambers, particularly two sub-chambers each shaped to properly receive a corresponding earpiece.

Next, further exemplary embodiments of the audio playback apparatus will be explained. However, these embodiments also apply to the cable management system and to the method.

In the audio playback apparatus, the cables may be guided through the opening holes in the sidewalls of the casing, and the first and second electric members may be arranged at the end portions of the first cable and of the second cable, respectively. In such a scenario, the first electric member may be an audio reproduction unit adapted for reproducing audio data, that is for generating acoustic waves. For example, the first electric member may comprise earpieces, headphones, loudspeakers, etc. Two or more first cables or wires and correspondingly two or more first electric members may be provided, and two or more guiding holes may be provided at one side of the casing through which the two or more first cables may be guided.

The second electric member may be a connector unit adapted to be connected to a periphery device or any other source of audio content such as a CD player, an MP3 player, a mobile phone, a harddisk, etc. and may be adapted for transmitting the audio data from the periphery device to the audio reproduction unit. In other words, the electronic audio signals may be transmitted from the periphery device through the second cable(s) and the first cable(s), and from there to the audio reproduction unit(s) which may generate acoustic waves based on the electronic audio data.

The audio reproduction unit may comprise one or more headphones, earpieces and/or loudspeakers. For instance, when being used in a headset, two loudspeakers may be provided which are adapted, arranged and designed to be functionally coupled to ears of a human user. When operating the audio playback device, the user may install the two loudspeakers on/in the ears which may require to bend the cables along a significant portion thereof. In such an operation mode, the user may take wound cable material from the casing to expose a significant portion of the cables for convenient wear by the user. In another operation mode, the user may wish not to playback audio data by the audio playback apparatus, but to tidy up the audio playback apparatus with low effort. For this purpose, the user may wind the cable around the casing, thereby preventing cable jam with a single hand motion.

Furthermore, a control unit or adjustment unit may be arranged at the casing and may be adapted to enable a user to control an audio playback property of the audio playback device. Therefore, in a very intuitive manner, a user may operate the control unit arranged directly at an outer surface of the casing for a convenient control of the audio playback properties. For example, a volume of the speech to be reproduced may be controlled. It is also possible to mute the audio transmission completely, regarding the playback via the loudspeakers and/or regarding capturing audio data by a microphone. Also, a frequency distribution (such a mix of bass and treble components) of the audio data may be manipulated, thereby providing an equalizer function. Also a balance control is possible allowing to individually adjust loudness of audio content played back by different loudspeakers of a multi-speaker system (such as a stereo system or a 5.1 system). Furthermore, the control unit may allow a user to adjust a playback operation, such as play, pause, stop, fast forward, fast reverse, slow motion, etc. Therefore, a normal playback mode and a trick playback mode can be adjusted conveniently.

The casing and/or the cover element may comprise a plastic material (for instance polycarbonate (PC), acrylonitrile butadiene styrene (ABS), silicone, santoprene), a textile material (for instance cotton, polyamide) or a combination thereof (for instance PC with silicon, ABS with cotton).

The device for processing audio data may be realized as at least one of the group consisting of an audio surround system, a mobile phone, a headset, a loudspeaker, a hearing aid, a television device, a video recorder, a monitor, a gaming device, a laptop, an audio player, a DVD player, a CD player, a harddisk-based media player, an internet radio device, a public entertainment device, an MP3 player, a hi-fi system, a vehicle entertainment device, a car entertainment device, a medical communication system, a body-worn device, a speech communication device, a home cinema system, a home theatre system, a flat television, an ambiance creation device, a subwoofer, and a music hall system. Other applications are possible as well.

The audio playback apparatus may further comprise a microphone which may be arranged/attached at the casing or may be embedded therein. Such a configuration may be highly advantageous for a bidirectional communication system (such as a mobile phone) since the outer surface of the casing may be co-used synergetically to attach one or more microphones thereto. In such an embodiment, the audio playback apparatus may be used, for example for a mobile phone allowing a user to listen to a communication partner by the loudspeakers and to simultaneously transmit speech via the microphone and the cables to a communication partner device.

However, although the system according to an embodiment of the invention primarily intends to improve the handling of sound or audio playback devices, it is also possible to apply the system for a combination of audio data and visual data. For instance, an embodiment of the invention may be implemented in audiovisual applications like a portable video player or a home cinema system in which cable-bound applications are involved.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 and FIG. 2 illustrate an audio playback apparatus according to an exemplary embodiment of the invention in different views and in an operation state in which cables are not wound around a casing.

FIG. 3 and FIG. 4 illustrate the audio playback apparatus of FIG. 1 and FIG. 2 in different views and in an operation state in which cables are wound around a casing along their entire length.

FIG. 5 and FIG. 6 illustrate the audio playback apparatus of FIG. 1 and FIG. 2 in different views and in an operation state in which cables are partially wound around a casing.

FIG. 7 and FIG. 8 illustrate the audio playback apparatus of FIG. 1 and FIG. 2 in different views and in an operation state in which the casing is open.

### DESCRIPTION OF EMBODIMENTS

The illustration in the drawing is schematically. In different drawings, similar or identical elements are provided with the same reference signs.

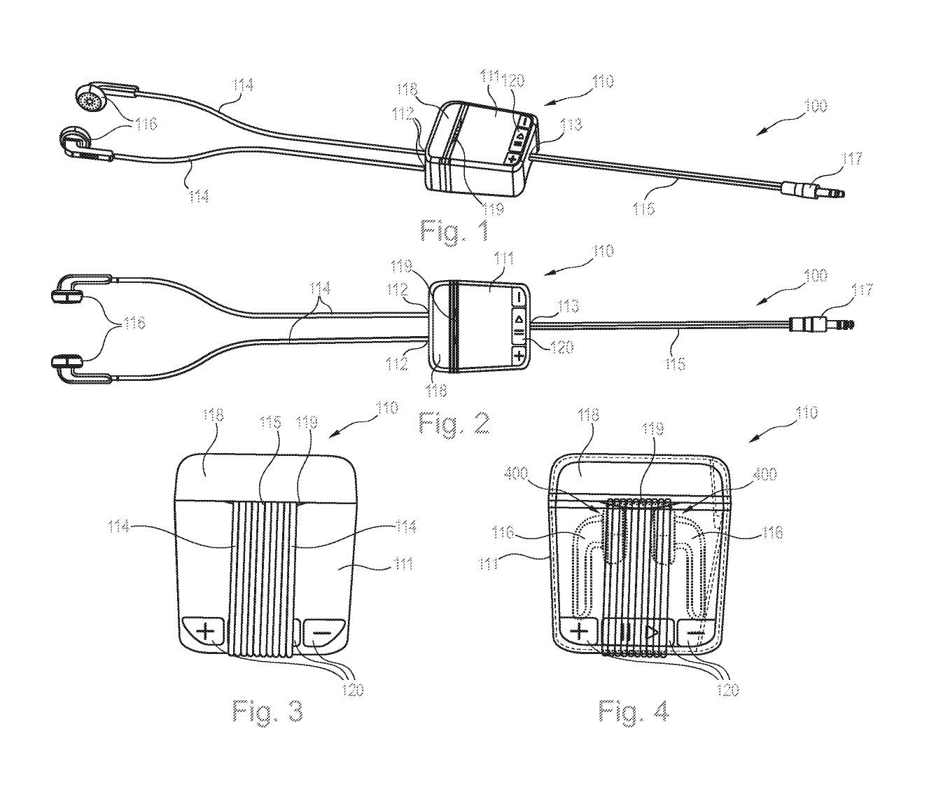

In the following, referring to FIG. 1 to FIG. 8, an audio playback apparatus 100 according to an exemplary embodiment of the invention will be explained. The various figures show the audio playback apparatus 100 in different operation modes and from different views.

FIG. 1 shows the audio playback apparatus 100 comprising two first cables 114 each connected to an assigned one of two earpieces 116 and each being adapted for carrying electric audio signals. A second cable 115 (which may include a plurality of wires each carrying an electronic audio signal) is connected to a plug 117 and is adapted for carrying audio signals. Furthermore, a cable management device 110 is provided which will be explained below in more detail and in which the cables 114, 115 are mounted.

During use, a user may insert the plug 117 into a corresponding socket (not shown) of a periphery device/audio source such as a CD player or an MP3 player. Then, the periphery device may supply electronic signals to the plug 117 which may be transported through the cable 115 through an interior of the cable management device 110, from there to the first cables 114 and finally to the earpieces 116 for audio reproduction.

The cable management device 110 comprises a casing 111 which has two first guiding openings 112 through which the two first cables 114 connected to the earpieces 116 are guidable. The casing 111 has, on an opposing side with regard to the first guiding openings 112, a second guiding opening 113 through which the second cable 115 connected to the plug 117 is guided. Within the casing 111, the cable 115 is electrically connected to the cable 114 without interruption. Thus, inside of the casing 111, the cable 115 passes over directly into the cable 114.

One or more cables (each including one or a plurality of electrically insulated wires, leads or conductors) may be guided through each of the guiding openings. For instance, in the embodiment of FIG. 1, two guiding openings 112 are provided each sized to receive a single cable 114. In contrast to this, two cables 115 are guided together through a single guiding opening 113 which may therefore be dimensioned larger than each of the two guiding openings 112. The number of wires within the cables 114 and 115 may be equal, since all electric signals guided through the cables 115 may also be guided through the cables 114 for subsequent audio reproduction. The number of wires (that is to say signal carrying conductors) per cable may or may not be equal for all cables. The number of current-carrying wires within a cable may be one or larger than one. In a multi-conductor configuration, each individual conductor or wire may be surrounded by an assigned insulator sheath, wherein all insulated wires may be surrounded by an outer insulating sheath. Also twin cables may be implemented, that is to say a cable composed of two parallel conductors separated from each other by a ribbon-like insulator or encased by a foam insulator.

The casing 111 further has an accommodation chamber (not shown in FIG. 1, but indicated with reference numeral 400 in FIG. 4 and FIG. 8) for accommodating the earpieces 116. A foldable cover element 118 which may also be denoted as a cap is pivotably mounted on the casing 111 to selectively expose or cover the accommodation chamber 400.

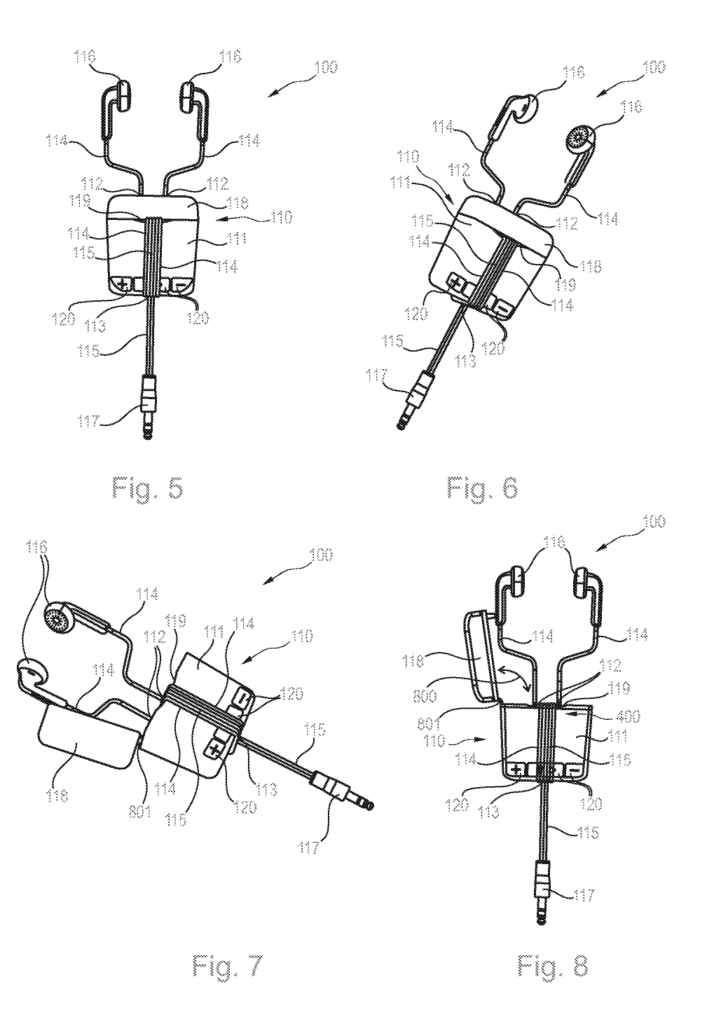

The casing 111 is adapted to allow for a winding of the first cables 114 and/or of the second cables 115 partly or entirely around the casing 111. In the operation state shown in FIG. 1 and FIG. 2, the cables 114, 115 are not wound around the casing 111 but are in an extended configuration. In contrast to this, FIG. 3 and FIG. 4 show an operation state of the audio playback apparatus 100 in which the cables 114 and 115 are entirely wound around the casing 111. In FIG. 5 and FIG. 6, the cables 114, 115 are partially wound around the casing 111, however the cover element 118 is closed or connected to the casing 111. In FIG. 7 and FIG. 8, the cables 114, 115 are again partially wound around the casing 111, but the foldable cover element 115 is folded along a folding arrow 800 and is mounted foldably on an assembly axis 801.

As can be taken from FIG. 1 to FIG. 8, the casing 111 has a recess 119 in a surface portion adjacent to the cover element 118 when covering the accommodation chamber 400 to thereby allow for a winding of the first cables 114 and/or the second cables 115 around the casing 111 even when the cover element 118 covers the accommodation chamber 400. Therefore, when the cables 114, 115 are wound around the casing 111, they are partially received or accommodated within the recess 119, preventing damage of the cables 114, 115 even when the cover element 118 is closing the accommodation chamber 400.

As can be taken particularly from FIG. 4, the accommodation chamber 400 is shaped and dimensioned to be capable of receiving the earpieces 116 in a tidied up operation mode.

Adjustment buttons 120 are provided which allow to increase the volume of the audio playback (via the button with the “+”), for decreasing the volume of the played back audio (see button with the “−”). By means of a control button between the “+” and the “−” button, it is possible to play or stop playback.

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. A cable management device, the cable management device comprising:
a casing having a first guiding opening through which a first cable connected to a first electric member is guidable, a second guiding opening through which a second cable connected to a second electric member is guidable, and an accommodation chamber for accommodating at least the first electric member; and
a cover element being movably mountable on the casing to selectively expose and cover the accommodation chamber.

2. The cable management device according to claim 1,
wherein the casing is adapted to wind at least a portion of at least one of the first cable and the second cable around the casing.

3. The cable management device according to claim 1,
wherein the casing has a recess in a surface portion adjacent to the cover element when covering the accommodation chamber to thereby allow for a winding of at least a portion of at least one of the first cable and the second cable around the casing in an operation state in which the cover element covers the accommodation chamber.

4. The cable management device according to claim 1,
wherein the cover element is pivotably mounted on the casing to selectively expose and cover the accommodation chamber by pivoting the cover element with respect to the casing.

5. The cable management device according to claim 1,
wherein the cover element is foldably mounted on the casing to selectively expose and cover the accommodation chamber by folding the cover element with respect to the casing.

6. The cable management device according to claim 1,
wherein at least one of the casing and the cover element comprises at least one of a plastic, a textile, and a combination thereof.

7. The cable management device according to claim 1,
wherein the accommodation chamber is adapted for accommodating two earpieces.

8. An audio playback apparatus, the audio playback apparatus comprising:
a first cable connected to a first electric member and being adapted for carrying audio signals;
a second cable connected to a second electric member and being adapted for carrying audio signals; and
a cable management device according to claim 1;
wherein the first cable is guided through the first guiding opening of the cable management device; and
wherein the second cable is guided through the second guiding opening of the cable management device.

9. The audio playback apparatus according to claim 8,
wherein the first electric member is an audio reproduction unit adapted for reproducing audio data in accordance with audio signals carried by the first cable.

10. The audio playback apparatus according to claim 9,
wherein the second electric member is a connector unit adapted to be connected to an audio data source and adapted for transmitting the audio signals from the audio data source to the audio reproduction unit.

11. The audio playback apparatus according to claim 9,
wherein the audio reproduction unit comprises at least one of headphones, earpieces, and loudspeakers.

12. The audio playback apparatus according to claim 8,
further comprising an adjustment unit arranged at the casing and adapted to enable a user to adjust an audio playback property of the audio playback apparatus.

13. The audio playback apparatus according to claim 12,
wherein the adjustment unit is adapted as at least one of a volume control, an equalizer, a balance control, a playback operation mode adjustment unit, and a mute switch.

14. The audio playback apparatus according to claim 8,
wherein the first cable is one of electrically coupled and couplable to the second cable.

15. The audio playback apparatus according to claim 8,
wherein the audio playback apparatus is at least one of an audio surround system, a mobile phone, a headset, a headphone playback apparatus, a loudspeaker playback apparatus, a hearing aid, a television device, a video recorder, a monitor, a gaming device, a laptop computer, an audio player, a DVD player, a CD player, a harddisk-based media player, a radio device, an internet radio device, a public entertainment device, an MP3 player, a hi-fi system, a vehicle entertainment device, a car entertainment device, a medical communication system, a body-worn device, a speech communication device, a home cinema system, a home theatre system, a flat panel television apparatus, an ambiance creation device, a subwoofer, and a music hall system.

16. A method of managing cables, comprising:
providing a cable management device according to claim 1; and
winding at least a portion of at least one of the first cable and the second cable around the casing.

17. The method of claim 16,
further comprising accommodating at least the first electric member (116) in the accommodation chamber.

18. The method of claim 17,
further comprising moving the cover element to cover the accommodation chamber after accommodating at least the first electric member in the accommodation chamber.
